(19) United States
(12) Patent Application Publication
(10) Pub. No.: US 2006/0174447 A1
(43) Pub. Date: Aug. 10, 2006

(54) Disposable window handle

(76) Inventors: Glen Wolf, Owatonna, MN (US); Brian Dallmann, Owatonna, MN (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 11/051,395

(22) Filed: Feb. 4, 2005

(51) Int. Cl. B25G 3/32

(52) U.S. Cl. 16/422

(57) ABSTRACT

A disposable window handle for use in installing a hinged window assembly. The handle includes a main body and a leg. The main body has a first end and a second end. The main body has an aperture formed therein proximate the first end. The aperture is adapted to receive a spindle on a window operator. The leg extends from the main body proximate the second end.

### FIELD OF THE INVENTION

The invention relates generally to handles for operating windows. More particularly, the present invention relates to disposable windows handles.

### BACKGROUND OF THE INVENTION

There are many types of windows that generally include a frame in which a window assembly having at least one piece of glass is mounted. One type of window that is used in residential and commercial applications is hinged windows.

In hinged windows, the window assembly pivots with respect to the frame. Pivoting of the window assembly with respect to the frame is commonly controlled using a rotary window operator.

The rotary window operator includes at least one arm that extends from the window frame to the window assembly. The arm includes a spindle extending therefrom opposite the window assembly to which a handle is attached. Rotating the handle thereby causes the window assembly to pivot between the open and closed positions.

To verify installation of locked awning and casement style windows, an installer must unlock the window and then fully open the window assembly to ensure that it functions properly through its range of motion The installer must then close the window before re-locking it.

Although there is a need to test the operability of hinged windows during various stages of the window manufacturing, assembly, construction and installation process, it is not desirable to attach and leave the handles on the windows after manufacturing assembly to minimize damage to the components of the window. Delaying attachment of the handle to the window also reduces the potential of the handle being damaged during storage, distribution and installation.

The concept of a disposable window handle is discussed in Annes, U.S. Patent Publication No. 2004/0226136. The Annes disposable window handle not only enables the window to be operated during installation but also actuates the link and lock assembly.

### SUMMARY OF THE INVENTION

An embodiment of the invention is directed to a disposable window handle for use in assembly, storage, shipment, and installation of a window assembly. The handle includes a main body and a leg. The main body has a first end and a second end. The main body has an aperture formed therein proximate the first end. The aperture is adapted to receive a spindle on a rotary window operator. The leg extends from the main body proximate the second end.

Another embodiment of the invention is directed to a rotary window operator and handle assembly having a window operator and a window handle. The window operator has a spindle extending therefrom for operating a window. The window operator also has a recess formed therein.

The window handle has a main body with a first end and a second end. The window handle has an aperture formed therein proximate the first end. The aperture is adapted to receive the spindle. The window handle has a leg extending therefrom proximate the second end. The recess is adapted to at least partially receive the leg to prevent the window handle from rotating with respect to the window operator.

Another embodiment of the invention is directed to a method of fabricating a rotary window operator and handle assembly. The method includes forming a window operator having a spindle extending therefrom and having a recess formed therein. The method also includes forming a window handle having a main body with a first end and a second end. The window handle has an aperture formed therein proximate the first end. The window handle has a leg extending therefrom proximate the second end. The main body has a first side from which the leg extends and a second side that is substantially opposite the first side.

The first side is oriented towards the window operator. The window handle is attached to the window operator by extending the spindle into the aperture. Rotation of the window handle with respect to the window operator is limited by at least partially extending the leg into the recess.

### BRIEF DESCRIPTION OF THE DRAWINGS

FIG. 1 is a perspective view of a disposable window handle in a first position with respect to a rotary window operator.

FIG. 2 is a top view of the disposable windows handle in the first position.

FIG. 3 is a perspective view of the disposable window handle in a second position with respect to the rotary window operator.

FIG. 4 is a top view of the disposable window handle in the second position.

FIG. 5 is a side view of an alternative embodiment of the disposable window handle.

FIG. 6 is a side view of an alternative embodiment of the disposable window handle.

### DETAILED DESCRIPTION OF THE PREFERRED EMBODIMENTS

The invention is directed to a window handle, as illustrated at 10 in the Figures, for use during assembly, storage, shipping and installation of a window. Handle 10 may also be used as a permanent window handle. However, in accordance with a preferred embodiment, handle 10 is disposable.

The disposable window handle 10 is attached to and remains with a rotary window operator 12 to protect the window (not shown) and hardware finish while enabling the window to be opened and closed during assembly and installation by reversing the same handle.

As noted above, during the assembly and installation of awning and casement style windows it is often necessary to open and close the window to confirm that the window operates correctly. However, attaching a conventional handle to the window during the manufacturing assembly process and leaving the handle attached to the window during storage, shipping and installation can not only lead to the handle being damaged but also the handle causing damage to the window operator.

Alternatively, storing and shipping the window with the drive spindle of the window operator 12 exposed can result in damage caused by contact with adjacent windows or window operators.

The disposable window handle 10 of the invention is preferably fabricated from a single piece component with an elongated main body 18 having a first end 20 and a second end 22. To minimize the potential of the disposable window handle 10 causing damage to objects that it contacts, the disposable window handle 10 preferably has a curved profile and has curved ends.

While it is possible for an interior region of the disposable window handle to be substantially solid, the disposable window handle 10 is preferably fabricated with a side wall 24 that defines a recess 26 to reduce the amount of material needed to fabricate the disposable window handle 10. A thickness of the side wall 24 is selected to provide the disposable window handle 10 with sufficient structural rigidity during shipping and use.

The disposable window handle 10 is preferably formed of plastic with all of the components being integrally molded. Typically, the disposable window handle 10 is fabricated using an injection molding process. It is also possible to form the disposable window handle 10 from metal such as using a casting process. Other options for the disposable window handle 10 include fabricating the disposable window handle 10 from a semi-rigid foam or fabricated sheet metal.

While it is possible for the disposable window handle 10 to have a single piece construction to minimize the costs associated with manufacturing the disposable window handle 10, it is possible to form the disposable window handle 10 in two parts that are pivotally attached to each other so that the disposable window handle 10 can be pivoted away from the window operator 12 to facilitate use of the disposable window handle 10 where the window includes sill extensions.

The disposable window handle 10 has a spindle drive aperture 30 formed therein proximate the first end 20. The aperture 30 may comprise a variety of shapes, including, square, triangular, hex, octal, D-shaped, etc. In one embodiment, aperture 30 extends from an upper surface 32 of the disposable window handle 10 to a lower surface 34 of the disposable window handle 10. In another embodiment, aperture 30 extends only through a lower surface 34 of the disposable window handle 10. Upper surface 32 may be tapered from the first end 20 to the second end 22 such that the distance between upper surface 32 and lower surface 34 is larger at first end 20 than the distance between upper surface 32 and lower surface 34 at second end 22. This configuration provides clearance for between handle 10 and window operator 12.

In a preferred embodiment, aperture 30 has a substantially cylindrical configuration with a plurality of splines 40 extending radially inward in a spaced-apart relationship. The splines 40 are adapted to engage a spindle 42 extending from the window operator 12. When the disposable window handle 10 is attached to the window operator 12, the spindle 42 resists rotation with respect to the aperture 30.

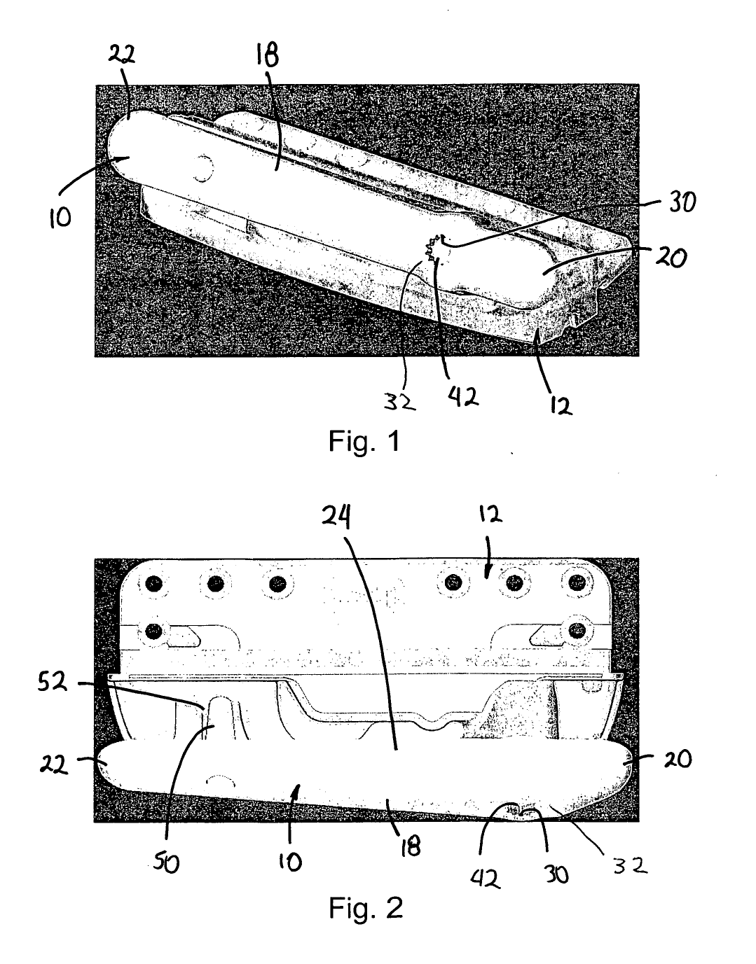

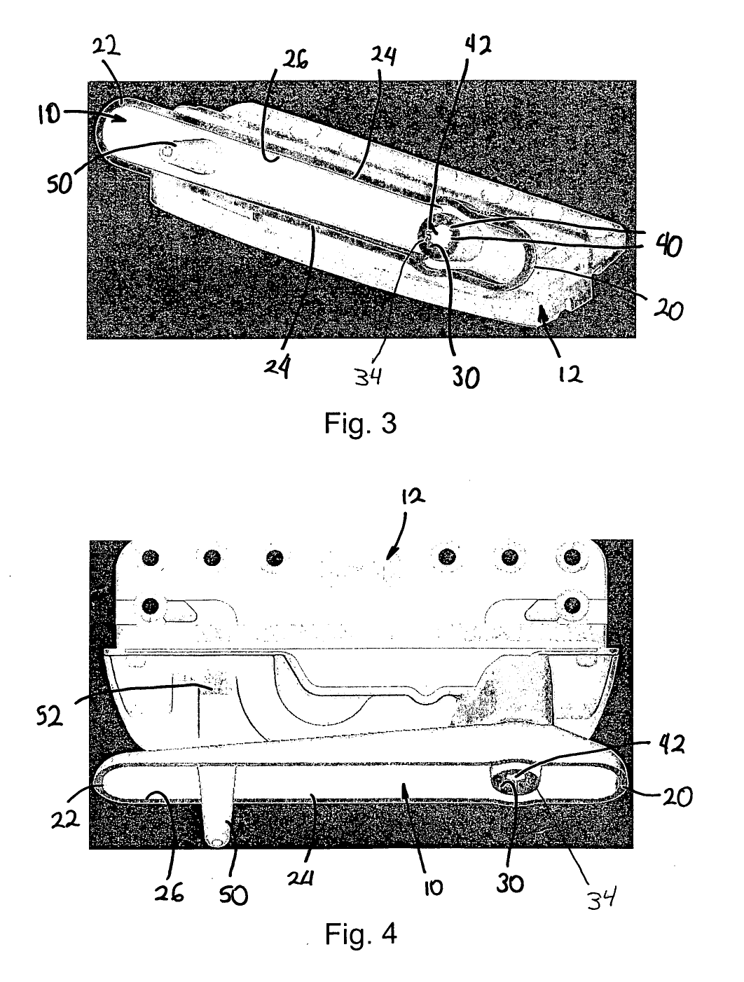

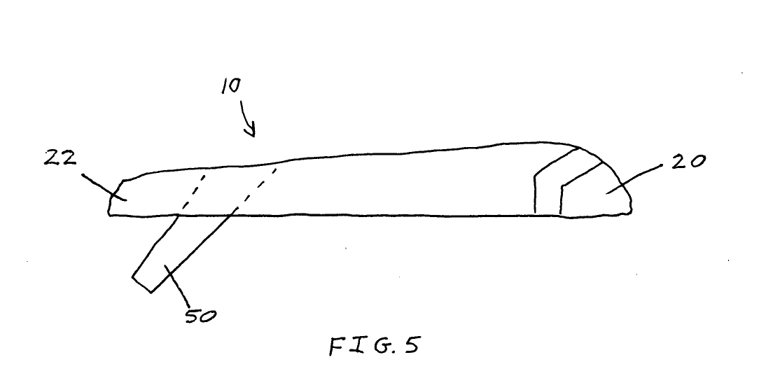

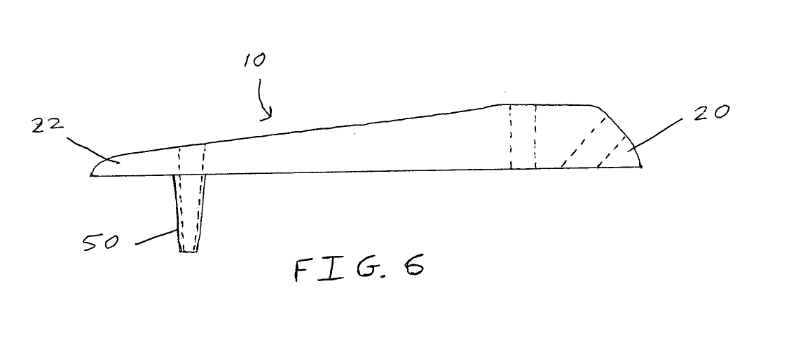

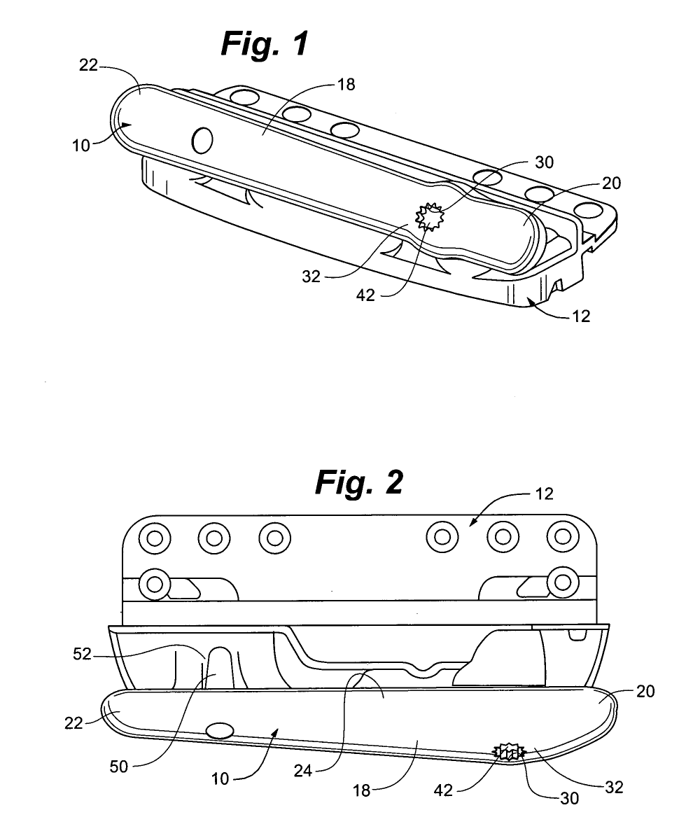

Proximate the second end 22 of the disposable window handle 10, a leg 50 extends therefrom. When the disposable window handle 10 is attached to the window operator 12 in the first configuration (FIGS. 1-2), the leg 50 extends into a recess 52 on the window operator 12 to help prevent the disposable window handle 10 from rotating with respect to the window operator 12.

Rotating the disposable window handle 10 with respect to the window operator 12 during storage and shipping could not only result in damage to the disposable window handle 10 but also can lead to the disposable window handle 10 causing damage to other objects located in proximity to the window such as other windows.

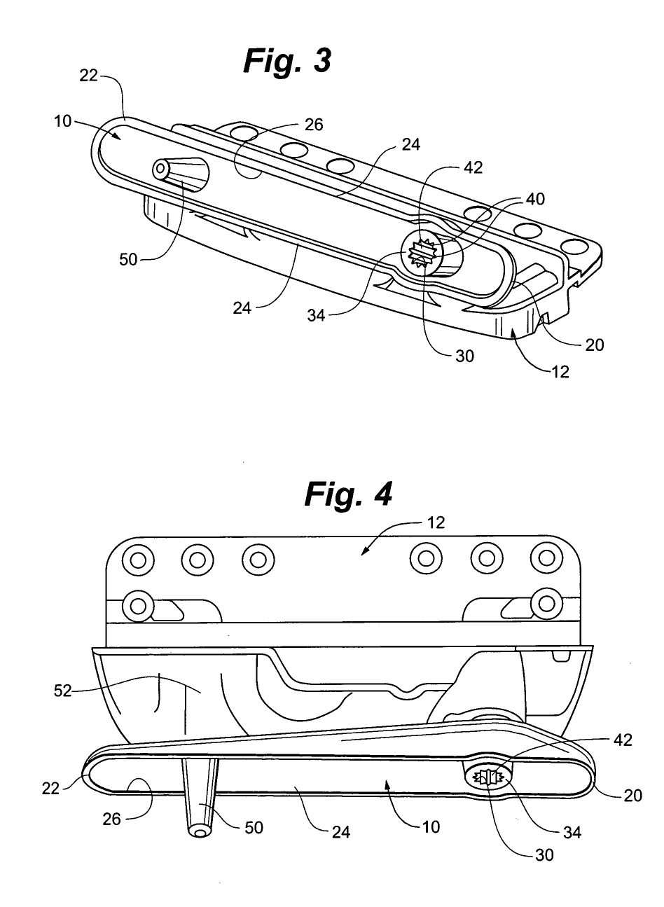

When the disposable window handle 10 is attached to the window operator 12 in the second configuration (FIGS. 3-4), the leg 50 extends away from the window operator 12. The leg 50 can thereby be used to facilitate rotation of the disposable window handle 10 for opening and closing the window.

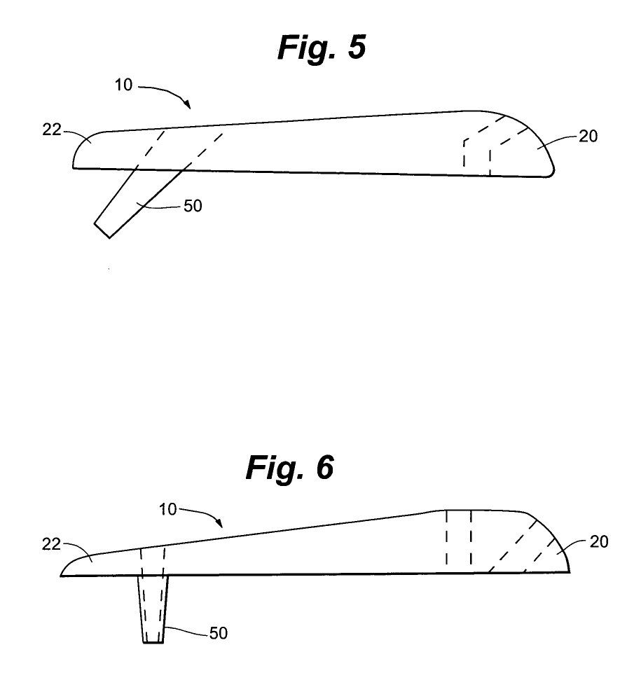

In light of the preceding functions of the leg 50, the leg 50 should be sufficiently large to facilitate use of the leg 50 when rotating the disposable window handle 10. The leg 50 should also be sufficiently small so that the leg 50 fits into recesses on a variety of styles of rotary window operators. In one embodiment, the leg 50 is tapered so that its diameter is wider proximate where the leg 50 is attached to the disposable window handle 10. In another embodiment, leg 50 extends from window handle 10 at an angle of between about 20 degrees and about 160 degrees as shown in FIG. 5. In yet another embodiment, leg 50 is perpendicular to the handle 10 as shown in FIG. 6.

In operation, the disposable window handle 10 engages the window operator 10 by inserting the spindle 42 into the aperture 30 so that the leg 50 extends away from the window operator, as illustrated in FIGS. 3 and 4. In one embodiment, the spindle 42 is inserted into the aperture 30 until the splines on the spindle engage the splines on the aperture 32.

Once there is proper engagement between the disposable window handle 10 and the spindle 42, the window assembly is opened with respect to the frame assembly by rotating the disposable window handle 10. In a similar but reverse manner, the window is closed by rotating the disposable window handle 10 in the opposite direction of opening.

After the window assembly is closed, the disposable window handle 10 is removed from the spindle 42 by disengaging the splines on the spindle 42 from the splines on the aperture 30. The disposable window handle 10 is reversed so that the leg 50 is facing towards the window operator 12. The spindle 42 is inserted into the aperture 30 until the splines on the spindle 42 engage the splines on the aperture 30. The leg 50 extends into a recess 52 on the window operator 12, which prevents the disposable window handle 10 from rotating with respect to the window operator 12.

In this configuration, the disposable handle covers a significant portion of the exposed surfaces on the window operator 12 to thereby prevent these exposed surfaces from being damaged during storage, shipping, and other phases of the construction. Once the construction is substantially completed, the disposable window handle 10 is removed from the spindle 42 and the permanent handle is attached to the window operator 12.

It is contemplated that features disclosed in this application, as well as those described in the above applications incorporated by reference, can be mixed and matched to suit particular circumstances. Various other modifications and changes will be apparent to those of ordinary skill.

1-20. (canceled)

21. A rotary window operator and handle assembly comprising:
a window operator having a selectively rotatable spindle extending therefrom for operating a window; and
an elongate handle presenting a first side, an opposing second side, a first end, and a second end, the handle defining structure in each of the first and second sides proximate the first end for receiving and engaging the spindle so that the spindle is rotatable with the handle, the handle selectively reversibly receivable on the spindle in each of a first orientation wherein the spindle extends into the handle from the first side of the handle and a second orientation wherein the spindle extends into the handle from the second side of the handle, the first side of the handle and the operator having corresponding structures for inhibiting rotation of the handle when the handle is received on the spindle in the first orientation.

22. The window operator and handle assembly of claim 21, wherein the structure in each of the first and second sides for receiving and engaging the spindle comprises an aperture extending through the handle between the first and second sides.

23. The window operator and handle assembly of claim 21, wherein the corresponding structures for inhibiting rotation of the handle when the handle is received on the spindle in the first orientation comprise a projection extending from the first side of the handle and a structure for receiving the projection on the operator.

24. The window operator and handle assembly of claim 21, wherein the handle is made by a process comprising a step of molding the handle from plastic in a single piece.

25. A rotary window operator and handle assembly comprising:
a window operator having a selectively rotatable spindle extending therefrom for operating a window; and
an elongate handle presenting a first side, an opposing second side, a first end, and a second end, the handle having means proximate the first end for receiving and engaging the spindle so that the spindle is rotatable with the handle, the means for receiving and engaging the spindle enabling the handle to be received on the spindle in each of a first orientation wherein the first side of the handle faces the operator and a second orientation wherein the second side of the handle faces the operator, the first side of the handle and the operator having cooperating means for inhibiting rotation of the handle when the handle is received on the spindle in the first orientation.

26. The window operator and handle assembly of claim 25, wherein the means for receiving and engaging the spindle comprises an aperture extending through the handle between the first and second sides.

27. The window operator and handle assembly of claim 25, wherein the cooperating means for inhibiting rotation of the handle comprises a projection extending from the first side of the handle and a structure for receiving the projection on the operator.

28. The window operator and handle assembly of claim 25, wherein the handle is made by a process comprising a step of molding the handle from plastic in a single piece.

29. A handle for a window operator having a selectively rotatable spindle, the handle presenting a first side, an opposing second side, a first end, and a second end, the handle defining structure in each of the first and second sides proximate the first end for receiving and engaging the spindle so that the spindle is rotatable with the handle, the handle selectively reversibly receivable on the spindle in each of a first orientation wherein the spindle extends into the handle from the first side of the handle and a second orientation wherein the spindle extends into the handle from the second side of the handle, the first side of the handle having structure for engaging the operator to inhibit rotation of the handle when the handle is received on the spindle in the first orientation.

30. The handle of claim 29, wherein the structure in each of the first and second sides for receiving and engaging the spindle comprises an aperture extending through the handle between the first and second sides.

31. The handle of claim 29, wherein the structure for engaging the operator to inhibit rotation of the handle when the handle is received on the spindle in the first orientation comprises a projection extending from the first side of the handle.
